(19) United States
(12) Patent Application Publication
(10) Pub. No.: US 2017/0159467 A1
(43) Pub. Date: Jun. 8, 2017

(54) GUIDE VANE RING CASING FOR A TURBOMACHINE AND TURBOMACHINE HAVING A GUIDE VANE RING CASING

(71) Applicant: MTU Aero Engines AG, Muenchen (DE)

(72) Inventors: Lothar Albers, Muenchen (DE); Georg Zotz, Haimhausen (DE); Vitalis Mairhanser, Sigmertshausen (DE)

(21) Appl. No.: 15/367,930

(22) Filed: Dec. 2, 2016

(30) Foreign Application Priority Data
Dec. 4, 2015 (EP) 15198097.6

(51) Int. Cl. F01D 9/04; F01D 17/16

(52) U.S. Cl. CPC F01D 9/042; F01D 17/162; F01D 9/041; F05D 2240/128

(57) ABSTRACT

An inventive guide vane ring casing 10′ for a turbomachine has a casing surface 11 extending about and facing a central axis A, the casing surface having formed therein a plurality of receiving recesses 12′, each intended to receive a vane disk 21a of a guide vane 20. A radial cut-out 16 is formed between at least two adjacent receiving recesses 12′ in the casing surface 11 and connects the two receiving recesses. A turbomachine includes a plurality of guide vanes 20 as well as an inventive guide vane ring casing 10′, each of the receiving recesses 12′ in the guide vane ring casing having a guide vane disk 21a of a respective one of the guide vanes placed therein.

This claims the benefit of European Patent Application EP15198097.6, filed Dec. 4, 2015 and hereby incorporated by reference herein.

The present invention relates to a guide vane ring casing for a turbomachine, a segment of a guide vane ring casing, a kit for a turbomachine, and a turbomachine having a guide vane ring casing.

### BACKGROUND

Turbomachines (such as, for example, aircraft engines and stationary gas turbines) often have at least one guide vane row disposed in the compressor portion and including a plurality of guide vanes to establish optimum operating conditions. Preferably, the guide vanes each have one vane disk in a region to be positioned radially inwardly and one vane disk in a region to be positioned radially inwardly. Each of these vane disks may have a trunnion on its side that faces away from the airfoil. The guide vanes are fixed or to be fixed at their radially inner ends to an inner ring and at their radially outer ends to a guide vane ring casing. As used herein and unless otherwise stated, the terms “radial,” “axial,” and “circumferential” always refer to a central geometric axis of the guide vane ring casing (in the direction of an intended main flow), on which central geometric axis an axis of rotation of a rotor is positioned or to be positioned within the guide vane ring casing. Thus, in the assembled condition, the central geometric axis of the guide vane ring casing and a central axis of the inner ring preferably coincide with each other.

The guide vanes mounted or to be mounted between the inner ring and the guide vane ring casing are preferably mounted so to be pivotable about their longitudinal axes. To this end, the trunnions that are mounted on the guide vane ring casing (and then referred to as “adjusting trunnions”) may cooperate with an adjusting mechanism capable of effecting a change in angular position.

The guide vane ring casing may be composed of a plurality of guide vane ring casing parts, which may each have receiving recesses for vane disks. Such guide vane ring casing parts may include, for example, ring segments and/or axially separated parts.

The guide vane ring casing preferably has a plurality of radially extending receiving recesses, in each of which is or may be placed a corresponding vane disk of a guide vane. Such a vane disk serves to stabilize and support the guide vane. The receiving recess may be adapted to also receive a trunnion formed on the vane disk, possibly together with an associated bushing and/or sliding washer for the vane disk.

The receiving recesses in the guide vane ring casing are separated from one another by respective separating walls.

During manufacture of the guide vane ring casing and during operation of the guide vane ring, there is a risk that such a separating wall may partially yield and thus be pressed into an adjacent receiving recess, which will therefore no longer have its proper shape. This may prevent a vane disk from being received as intended. It may also happen during operation that the separating wall of the turbomachine is bent toward an adjacent receiving recess, as a result of which it may impair the turning capability of a guide vane placed therein.

In order to reduce the risk of such deformation of the receiving recesses, conventional guide vane ring casings are manufactured such that the separation walls must have a minimum wall thickness at their thinnest point.

### SUMMARY OF THE INVENTION

For a given inner circumference of the guide vane ring casing, the number of receiving recesses for vane disks (and thus the number of guide vanes that can be mounted) is determined by the predetermined vane disk size and by the minimum wall thickness to be met. Thus, these parameters impose limits on the ability to design the turbomachine with a large number of pivotable guide vanes or large vane disks. However, such a design and/or a minimum vane disk size are/is often advantageous from an aerodynamic standpoint and/or in terms of structural mechanics.

It is an object of the present invention to provide a technology that will improve the design of a guide vane row in terms of aerodynamics and/or structural mechanics.

The present invention provides a guide vane ring casing, a segment of a guide vane ring, a kit for a turbomachine, and a turbomachine. Advantageous embodiments are disclosed in the description and figures.

An inventive guide vane ring casing for a turbomachine has an inner casing surface extending about and facing a central (geometric) axis (preferably substantially along a lateral cylinder or cone surface), the central axis preferably being arranged such that, in the assembled condition, an axis of rotation of a rotor positioned within the guide vane ring casing coincides with the central axis.

The casing surface has formed therein a plurality of receiving recesses, each intended to receive a vane disk of a guide vane. The casing surface has a radial cut-out between at least two adjacent receiving recesses, the cut-out connecting the two receiving recesses (in the circumferential direction).

An inventive segment of a guide vane ring casing can be assembled with at least one further segment to form an inventive guide vane ring casing (according to one of the embodiments disclosed herein). It includes the at least two adjacent receiving recesses for vane disks, which are connected by a radial cut-out. Preferably, a segment according to the present invention is configured as a ring segment, for example, a half-ring, one-third of a ring or a quarter ring.

An inventive kit for a turbomachine includes an inventive guide vane ring casing according to one of the embodiments disclosed herein, as well as one or more guide vanes, each of which is placed or to be placed in a respective one of the receiving recesses of the guide vane ring casing.

A turbomachine according to the present invention includes a guide vane row including a plurality of guide vanes as well as an inventive guide vane ring casing according to one of the embodiments disclosed herein, each of the receiving recesses in the guide vane ring casing having a guide vane disk of a respective one of the guide vanes placed therein.

An inventive guide vane ring casing, an inventive segment of a guide vane ring casing, an inventive kit, and an inventive turbomachine each advantageously enable a guide vane arrangement in which a distance between adjacent guide vane disks is minimized, while at the same time avoiding the risk of a receiving recess becoming deformed. This is because, particularly when two adjacent receiving recesses have circular-cylindrical portions, they converge radially inwardly. Therefore, they have a smallest distance from each other in the region of the inner casing surface (facing the central axis). In accordance with the present invention, it is now no longer necessary to observe a minimum distance in this region to prevent an excessively thin separating wall from becoming adversely deformed in this region. In accordance with the present invention, a cut-out is formed in the casing surface between the receiving recesses in this region, so that, in this region, there is no separating wall that could become deformed.

In particular, a guide vane ring casing according to the present invention enables a design having a large number of guide vanes or large guide vane disks, thus improving the efficiency and durability of a turbomachine.

Preferably, the at least two receiving recesses have the same dimensions; i.e., are identical in configuration.

In an advantageous variant, at least two receiving recesses each have a substantially circular-cylindrical portion (e.g., a circular-cylindrical bore) extending radially with respect to the central axis of the guide vane ring casing. Such receiving recesses can receive correspondingly shaped guide vane disks having a circular-cylindrical portion, thereby providing for particularly secure and stable support and pivotability of the guide vanes.

In accordance with a preferred embodiment, the at least two receiving recesses are each adapted to receive a guide vane disk having a cylindrical adjusting trunnion at the side facing away from (i.e., opposite to) the airfoil.

To this end, the at least two receiving recesses may each have two concentric cylindrical portions, namely a radially more outward portion (for receiving an adjusting trunnion) and a radially more inward portion (for receiving the disk itself), the radially more outward portion being narrower than the radially more inward portion. The cut-out preferably extends radially (with respect to the guide vane ring casing and with respect to a rotary shaft) no further than to a (radial) depth of the radially more inward cylindrical portion of the receiving recesses. Thus, preferably, the cut-out connects only the radially inward portions (which have a larger diameter than the portions for receiving the adjusting trunnions). As described above, this allows the guide vanes to be arranged in closely spaced relationship while maintaining a high stability of the inserted guide vanes and keeping leakage low.

In accordance with an advantageous embodiment of the present invention, in such a radially inward portion, the receiving recesses have a radial depth (i.e., a radial extension into the guide vane ring casing) of preferably between 2 mm and 3 mm. Such dimensions enable reception of guide vane disks of conventional thickness (possibly together with a sliding washer) without the radially inner surfaces of the guide vane disks standing out from the inner casing surface (which would be disadvantageous from an aerodynamic standpoint).

In accordance with an advantageous embodiment, the cut-out has a radial extent that is less than a radial depth of at least one of the receiving recesses; i.e., a radially inner cylindrical portion of the receiving recess. In particular, a separating wall is formed between the at least two receiving recesses of a guide vane ring casing according to the present invention, the separating wall extending radially between a bottom surface of at least one of the receiving recesses and the radial cut-out, the bottom surface being a surface which radially outwardly bounds at least a portion of the receiving recess. In particular, in an embodiment where the receiving recess has a radially outer portion for receiving an adjusting trunnion and a radially inner portion for receiving the vane disk, the bottom surface preferably provides a radial contact surface for the vane disk and has an opening therein through which the adjusting trunnion may be passed.

Thus, the above-mentioned separating wall is preferably located radially further outward than the cut-out connecting the adjacent receiving recesses. In this region, circular-cylindrical portions of the receiving recesses may be spaced further apart, so that there is no risk of the separating wall becoming deformed in this region. Thus, the separating wall provides secure and stable support for inserted guide vanes in this region and, possibly, stable positioning of a sliding washer between the bottom surface and the vane disk, and thus in a region where a thickness of the separating wall is not critical because of the radially outwardly diverging receiving recesses.

Preferably, the separating wall has a base surface area which is inwardly curved (concave) on both sides in the circumferential direction, which allows it to receive an annular sliding washer with accurate fit and thus with minimum leakage.

In accordance with an advantageous embodiment, the separating wall has a radial height of between 1 mm and 1.5 mm. In this connection, the term “radial height” refers to a distance between a bottom of at least one of the receiving recesses and the radial cut-out. If the two receiving recesses have different radial depths, the bottom of the receiving recess that has the smaller depth must be selected.

Such a radial height reduces leakage between the at least two receiving recesses in a region that is not critical for the thickness of the separating wall and, in addition, enables reception of a sliding washer between the bottom of the receiving recess and a guide vane disk to be placed therein.

In an advantageous embodiment, the length of the separating wall in the axial direction is between 10 mm and 20 mm. This makes it possible to avoid an unfavorably small wall thickness laterally of a center of the cut-out (e.g., a center located in a narrowest region between two receiving recesses).

At a thinnest point in the circumferential direction, the separating wall preferably has a thickness of between 0.3 mm and 0.5 mm. Thus, on the one hand, the separating wall can be prevented from becoming deformed during insertion of the guide vanes or during operation and, on the other hand, such a thickness advantageously allows the guide vanes to be closely spaced from one another.

Preferably, sliding washers are placed in the receiving recesses between the guide vane ring casing and the guide vanes. An inventive kit and an inventive turbomachine may preferably include such sliding washers. The sliding washers may reduce friction during adjustment of the guide vanes.

Preferred exemplary embodiments of the present invention will be described in greater detail below with reference to the drawings. It is understood that individual elements and components can also be combined in other ways than those described. Corresponding elements are identified by the same reference characters throughout the figures and may not be described again for each figure.

### BRIEF DESCRIPTION OF THE DRAWINGS

In the schematic drawings,

FIG. 1 is a perspective view of a conventional guide vane ring casing;

FIG. 2 is a view of a portion of an exemplary guide vane ring casing according to the present invention;

FIG. 3 is an exploded view showing a portion of an exemplary inventive guide vane ring casing with a guide vane to be inserted.

### DETAILED DESCRIPTION

FIG. 1 shows a segment of a conventional guide vane ring casing 10 which, in the present example, is substantially half-ring shaped. Guide vane ring casing 10, together with a further, analogously configured segment (not shown), has a central geometric axis A which, in the assembled condition of the turbomachine, coincides with the axis of rotation of a rotor (not shown in the figure). For purposes of assembly; i.e., for assembly with other parts of the guide vane ring casing, the segment shown has a mounting rim 19 provided with holes for threaded fasteners.

The segment of a guide vane ring casing 10, as shown in FIG. 1, has three annular portions arranged in axial succession (vertical in the figure) at its inner casing surface 11, each annular portion having a plurality of receiving recesses 12 for vane disks of guide vanes. The portions have different radii, so that the inner casing surface tapers stepwise in the intended principal flow direction R (from bottom to top in the figure) within the portions. Located between the sections provided with receiving recesses 12 are portions of casing surface 11 which are each disposed on a lateral cylinder surface.

Each of receiving recesses 12 has at its center a trunnion socket 17 adapted to receive an adjusting trunnion formed on a guide vane disk. The adjusting trunnions, and thus the associated guide vanes, can preferably be pivoted via a radially outwardly disposed adjusting mechanism.

In FIG. 1, the guide vanes 20 have vane disks 21a for placement in the receiving recesses. At their ends opposite the vane disks 21a, guide vanes 20 have respective vane disks 21b, which are adapted to be placed in receiving recesses in an inner ring.

As can be seen from FIG. 1, receiving recesses 12 are separated by separating walls in a conventional manner. In particular in the narrowest portion (uppermost in the figure), these separating walls are very thin, so that deformations may occur as described above.

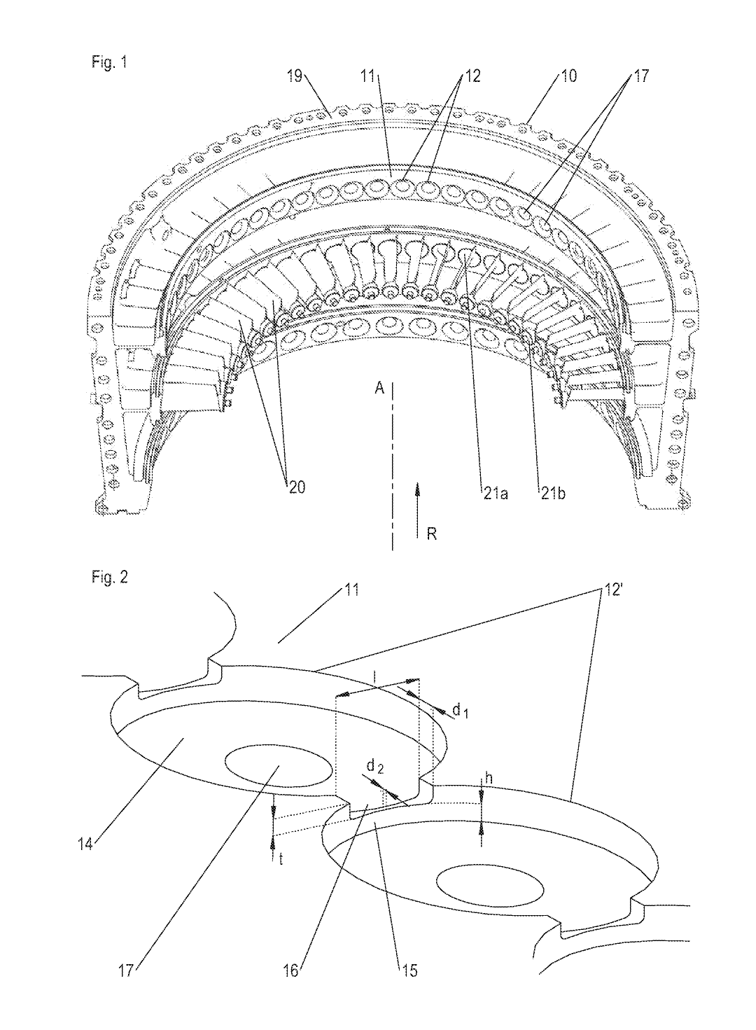

In contrast, FIG. 2 schematically shows a portion of a casing surface 11 of a guide vane ring casing according to the present invention, the casing surface facing a central axis of the guide vane ring casing.

Casing surface 11 is formed with receiving recesses 12′ in which radially outer vane disks of suitable guide vanes are to be placed. Receiving recesses 12′ each have an annular bottom surface 14 opposite their openings in casing surface 11, a trunnion socket 17 for an adjusting trunnion of the respective guide vane being disposed at the center of the bottom surface.

In the example shown, receiving recesses 12′ are all identical in configuration, and, in particular, have a substantially circular-cylindrical shape, from which the (also circular-cylindrical) trunnion socket 17 extends (concentrically).

Casing surface 11 has a radial cut-out 16 between the two adjacent receiving recesses 12′ shown in FIG. 2, the cut-out connecting the adjacent receiving recesses. The cut-outs each have a radial depth t, which is preferably in a range from 1 mm to 1.5 mm.

A separating wall 15 is formed between each two adjacent receiving recesses 12′, the separating wall extending between bottom 14 of the receiving recesses and cut-out 16 (i.e., radially with respect to a central axis of the guide vane ring casing). Separating wall 15 has a radial height h, which is preferably between 1 mm and 1.5 mm. Such a height advantageously enables centering of the vane disks and sliding washers to be inserted, and reduces leakage in this region.

In the axial direction (with respect to a central axis of the guide vane ring casing), the separating wall has a length 1, which is preferably between 10 mm and 20 mm. In the example shown, separating wall 15 has a base surface area which is inwardly curved on both sides in the circumferential direction. In the circumferential direction, separating wall 15 has a thickness d₁ at its thickest point (at its ends) and a thickness d₂ at its thinnest point. Preferably, d₂ is in a range from 0.3 mm to 0.5 mm, so that the risk of the separating wall becoming deformed can be minimized. Thickness d₁ (at the thickest point of separating wall 15) results from d₂, the length of the separating wall and the radius of receiving recesses 12′. Preferably, d₁ is in a range between 2.5 mm and 3 mm.

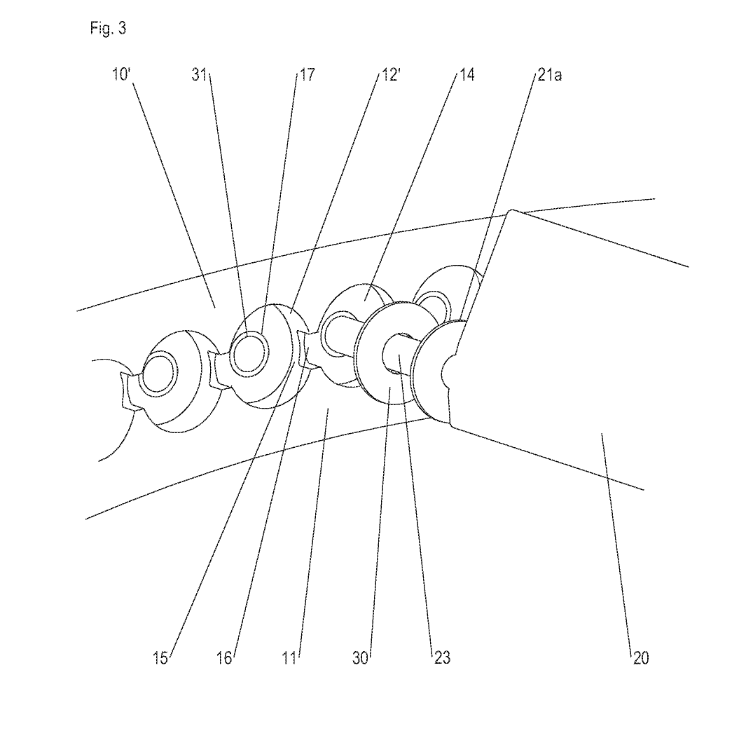

FIG. 3 shows a portion of a guide vane ring casing 10′ according to the present invention. Guide vane ring casing 10′ has a casing surface 11 provided with receiving recesses 12′, of which adjacent ones are connected by a respective cut-out 16 in casing surface 11. The receiving recesses each have a trunnion socket 17 in a bottom surface 14 thereof, the trunnion socket having inserted therein a bushing 31 for the adjusting trunnion 23 of a guide vane 20.

FIG. 3 exemplarily illustrates in an exploded view how such a guide vane 20 is to be inserted into the guide vane ring casing with a guide vane disk 21a and an adjusting trunnion 23 extending therefrom, an annular sliding washer 30, through which the adjusting trunnion is passed, being inserted between vane disk 21a and the bottom surface of receiving recess 12′.

An inventive guide vane ring casing 10′ for a turbomachine has a casing surface 11 extending about and facing a central axis A, the casing surface having formed therein a plurality of receiving recesses 12′, each intended to receive a vane disk 21a of a guide vane 20. A radial cut-out 16 is formed between at least two adjacent receiving recesses 12′ in casing surface 11 and connects the two receiving recesses.

An inventive segment of an inventive guide vane ring casing (according to one of the embodiments disclosed herein) includes the at least two adjacent receiving recesses 12′ connected by a radial cut-out 16.

An inventive kit for a turbomachine includes an inventive guide vane ring casing 10′ (according to one of the embodiments disclosed herein) as well as one or more guide vanes 20, each of which is to be placed in a respective one of the receiving recesses 12′ and/or at least a portion of which is placed therein.

A turbomachine according to the present invention includes a plurality of guide vanes 20, as well as an inventive guide vane ring casing 10′ (according to one of the embodiments disclosed herein), each of the receiving recesses 12′ in the guide vane ring casing having a guide vane disk 21a of a respective one of the guide vanes placed therein.

### LIST OF REFERENCE CHARACTERS

10, 10′ guide vane ring casing
11 casing surface
12, 12′ receiving recess
14 bottom surface
15 separating wall
16 cut-out
17 trunnion socket
19 mounting rim
20 guide vane
21a, 21b vane disk
23 adjusting trunnion
30 sliding washer
31 bushing
A central axis
R intended principal flow direction
d₁ thickness of the separating wall at its thickest point
d₂ thickness of the separating wall at its thinnest point
h radial height of the separating wall
l length of the separating wall (in the axial direction)
t radial depth of the cut-out

What is claimed is:

1. A guide vane ring casing for a turbomachine comprising:
a casing surface extending about and facing a central axis, the casing surface having formed therein a plurality of receiving recesses, each intended to receive a vane disk of a guide vane, wherein the casing surface has a radial cut-out between at least two adjacent receiving recesses, the cut-out connecting the two receiving recesses.

2. The guide vane ring casing as recited in claim 1 wherein the receiving recesses each have a substantially cylindrical portion extending radially into the casing.

3. The guide vane ring casing as recited in claim 1 wherein a separating wall is formed between the at least two receiving recesses, the separating wall extending radially between a bottom of at least one of the receiving recesses and the radial cut-out.

4. The guide vane ring casing as recited in claim 3 wherein the separating wall has a radial height of between 1 mm and 1.5 mm, or wherein the separating wall has a length of between 10 mm and 20 mm in an axial direction, or wherein at a thinnest point in a circumferential direction, the separating wall having a thickness of between 0.3 mm and 0.5 mm.

5. A segment of a guide vane ring casing for a turbomachine, the guide ring casing having a casing surface extending about and facing a central axis, the casing surface having formed therein a plurality of receiving recesses, each intended to receive a vane disk of a guide vane, wherein the casing surface has a radial cut-out between at least two adjacent receiving recesses, the cut-out connecting the two receiving recesses, the segment comprising:
the at least two adjacent receiving recesses connected by the radial cut-out.

6. A kit for a turbomachine comprising the guide vane ring casing as recited in claim 1 and at least one guide vane placed or to be placed in a respective one of the receiving recesses.

7. The kit as recited in claim 6 further comprising a plurality of sliding washers, each placed or to be placed in a respective one of the receiving recesses between the guide vane ring casing and a respective one of the at least one guide vane.

8. A turbomachine comprising:
a guide vane row including a plurality of guide vanes; and
a guide vane ring casing as recited in claim 1, each of the receiving recesses in the guide vane ring casing having a guide vane disk of a respective one of the guide vanes placed in. the receiving recess.

9. The turbomachine as recited in claim 8 further comprising a plurality of sliding washers, each of the sliding washers being placed in a respective one of the receiving recesses between the guide vane ring casing and a respective one of the guide vanes.
